(19) United States
(12) Patent Application Publication
(10) Pub. No.: US 2026/0203976 A1
(43) Pub. Date: Jul. 16, 2026

(54) APPARATUS AND METHOD OF PERFORMING IMAGE COLOR TRANSFORMATION BASED ON FOVEATED RENDERING

(71) Applicant: QUALCOMM Incorporated, San Diego, CA (US)

(72) Inventors: Rui ZHANG, Shanghai (CN); Yang XU, Shanghai (CN); Chunhua TANG, Shanghai (CN)

(21) Appl. No.: 19/139,057

(22) PCT Filed: Jan. 18, 2023
(86) PCT No.: PCT/CN2023/072866

§ 371 Date: Jun. 13, 2025

(51) Int. Cl. G06T 11/60; G06T 11/10

(52) U.S. Cl. CPC G06T 11/60; G06T 11/10

(57) ABSTRACT

An apparatus, including: a first color transform subsystem configured to color transform a first region of an input image to generate a first color transformed sub-image; a second color transform subsystem configured to color transform a second region of the input image to generate a second color transformed sub-image; and an image combiner configured to combine the first and second color transformed sub-images to generate an output image.

### FIELD

Aspects of the present disclosure relate generally to image processing, and in particular to, an apparatus and method of performing image color transformation based on foveated rendering.

### BACKGROUND

Color transformation is a process of transforming color information of a source or input image to a new color information of an output image for displaying purpose. The color transformation typically improves the accuracy of the colors produced by an associated display (e.g., a display of a mobile device, smart phone, or an XR viewer (e.g., virtual reality (VR), augmented reality (AR), or other, where X is a variable representing the type of reality viewer)). The color transformation may also be performed to produce a particular visual effect (e.g., cinematic, retro, animation, pseudo black and white, or other effect, that may also be user controllable) of images rendered by a display. Typically, color transformation is employed to enhance the user experience associated with the device (e.g., mobile device, smart phone, XR viewer, or other).

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus includes a first color transform subsystem configured to color transform a first region of an input image to generate a first color transformed sub-image; a second color transform subsystem configured to color transform a second region of the input image to generate a second color transformed sub-image; and an image combiner configured to combine the first and second color transformed sub-images to generate an output image.

Another aspect of the disclosure relates to a method. The method includes color transforming a first region of an input image to generate a first color transformed sub-image; color transforming a second region of the input image to generate a second color transformed sub-image; and combining the first and second color transformed sub-images to generate an output image.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example apparatus for performing color transformation in accordance with an aspect of the disclosure.

FIG. 2 illustrates a block diagram of another example apparatus for performing color transformation in accordance with another aspect of the disclosure.

FIG. 3A illustrates a diagram of an example image in accordance with another aspect of the disclosure.

FIG. 3B illustrates a block diagram of an example apparatus for performing color transformation of the image of FIG. 3A in accordance with another aspect of the disclosure.

FIG. 4A illustrates a diagram of another example image in accordance with another aspect of the disclosure.

FIG. 4B illustrates a block diagram of an example apparatus for performing color transformation of the image of FIG. 4A in accordance with another aspect of the disclosure.

FIG. 5A illustrates a diagram of another example image in accordance with another aspect of the disclosure.

FIG. 5B illustrates a block diagram of an example apparatus for performing color transformation of the image of FIG. 5A in accordance with another aspect of the disclosure.

FIG. 6 illustrates a block diagram of another example apparatus for performing color transformation in accordance with another aspect of the disclosure.

FIG. 7 illustrates a perspective view of an example wearable device (e.g., augmented reality (AR) glasses) in accordance with another aspect of the disclosure.

FIG. 8 illustrates a block diagram of an example personal area network (PAN) in accordance with another aspect of the disclosure.

FIG. 9 illustrates a flow diagram of an example method of performing color transformation by an example wearable device in accordance with another aspect of the disclosure.

FIG. 10 illustrates a flow diagram of another example method of performing color transformation by an example wearable device in accordance with another aspect of the disclosure.

FIG. 11 illustrates a flow diagram of another example method of performing color transformation by an example companion device on behalf of an example wearable device in accordance with another aspect of the disclosure.

FIG. 12 illustrates a flow diagram of another example method of performing color transformation of an input image in accordance with another aspect of the disclosure.

FIG. 13 illustrates a flow diagram of another example apparatus for performing color transformation of an input image in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Color transformation is a process of transforming color information of a source or input image to new color information of an output image for displaying purpose. The color transformation typically improves the accuracy and/or effect of the colors produced by an associated display (e.g., a display of a mobile device, smart phone, an XR viewer (e.g., virtual reality (VR), augmented reality (AR), or other, where X is a variable representing the type of reality viewer), etc.). The color transformation may also be performed to produce a particular visual effect (e.g., cinematic, retro, animation, pseudo black and white, or other effect, that may also be user controllable) of images rendered by a display. Typically, color transformation is employed to enhance the user experience with the associated device (e.g., mobile device, smart phone, XR viewer, or other).

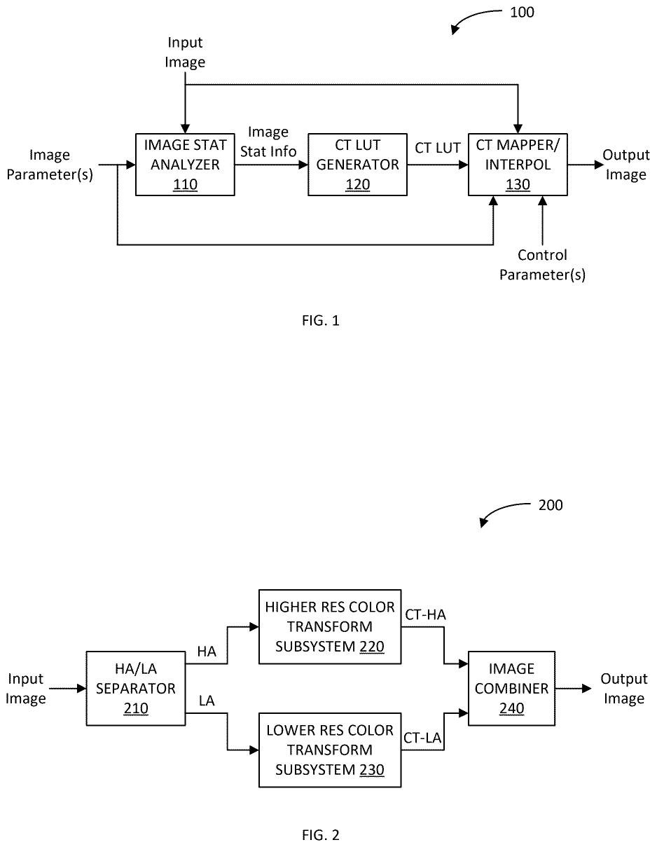

FIG. 1 illustrates a block diagram of an example apparatus 100 for performing color transformation in accordance with an aspect of the disclosure. The apparatus 100 may include an image statistics analyzer 110, a color transformation (CT) lookup table (LUT) generator 120, and a color transform mapper/interpolator 130.

The image statistics analyzer 110 includes a first input configured to receive a source or input image, and a second input configured to receive one or more image parameters associated with the input image. The one or more image parameters may include the dimensions (e.g., height and width) of the input image, as well as other metadata. The image statistics analyzer 110 is configured to generate image statistical information related to the input image using the one or more image parameters. For example, the image statistical information may provide the tonal (distribution) information of the input image, for example, in the form of an image histogram.

An image histogram includes a set of distinct tonal bins including a subset of relatively dark tonal bins, medium tonal bins, and light tonal bins. Associated with the set of tonal bins, the image histogram may provide the numbers of pixels of the input image that corresponds to the set of distinct tonal bins. For example, if the input image depicts a relatively dark scene, a corresponding image histogram may include high pixel numbers for the subset of relatively dark tonal bins, lower pixel numbers for the subset of medium tonal bins, and even lower pixel numbers for the subset of light tonal bins. Similarly, if the input image depicts a relatively light scene, a corresponding image histogram may include low pixel numbers for the subset of relatively dark tonal bins, higher pixel numbers for the subset of medium tonal bins, and even higher pixel numbers for the subset of light tonal bins.

The CT LUT generator 120 is configured to generate a color transformation (CT) lookup table (LUT) based on the image statistical information received from the image statistics analyzer 110. Considering some examples, if the image statistical information indicates that the input image depicts a relatively dark scene, the CT LUT generator 120 may generate a CT LUT that generally brightens the input image. Conversely, if the image statistical information indicates that the input image depicts a relatively light scene, the CT LUT generator 120 may generate a CT LUT that generally darkens the input image. If the image statistical information indicates that the input image depicts a medium brightness scene, the CT LUT generator 120 may generate a CT LUT that spreads or provides more contrast tonal components of the input image.

The generated CT LUT may be a three-dimensional (3D) or four-dimensional (4D) lookup table. For example, the 3D LUT may include as inputs for red, green, blue (RGB) tonal components of each pixel of the input image. The 3D LUT maps the RGB values of each pixel of the input image to new RGB values of each corresponding pixel of an output image. In additional to RGB, a 4D LUT may add the gamma or luminesce (γ) component for mapping the RGBγ of each pixel of the input image to new RGBγ values of each corresponding pixel of an output image. Other CT LUT may transform other tonal parameters, such as hue, saturation, brightness, and contrast. The RGB or RGBγ output values of an LUT are indexed by the RGB or RGBγ values of the input image, respectively.

The size of the CT LUT determines the accuracy or tonal resolution of the color transformation. For example, a 3×3×3 CT LUT, the RGB values of each pixel are indexed into one of three (3) by three (3) by three (3) indices of the CT LUT, respectively. Thus, a 3×3×3 may be a relatively low tonal resolution CT LUT. A relatively high tonal resolution CT LUT may have a size of 1024×1024×1024×120, where the RGBγ of each pixel are mapped to into one of 1024 by 1024 by 1024 by 120 indices, respectively. For example, an XR viewer may require a higher tonal resolution color transformation compared to a smart phone; and thus, the XR viewer may have a much larger size and/or more dimension CT LUT than a smart phone.

The CT mapper/interpolator 130 may configured to color transform the input image to generate an output image based on the CT LUT generated by the CT LUT generator 120, the one or more image parameters associated with the input image, and one or more control parameters that may set the interpolation used to perform the color transformation. As discussed, the size of the generated CT LUT may be of a fixed size (e.g., 3×3×3, 17×17×17, 1024×1024×1024×120, etc.). Because the size of the CT LUT is fixed, a set of RGB or RGBγ value ranges are used to index the RGB or RGBγ output values of the CT LUT to generate the output image. As a range of values are indexed to a particular value, interpolation may be employed to obtain more accurate RGB or RGBγ values for the pixels of the output image.

One option may be to not perform interpolation and use the particular output value for the entire range of input values. Another option may be to perform a trilinear or quad linear interpolations based on an input RGB or RGBγ values with respect to the indices of the CT LUT. Still another option may be to perform other types of interpolation based on input RGB or RGBγ values with respect to indices of the CT LUT. As discussed, the one or more control parameters may be used to select the particular interpolation (or none) performed to implement the color transformation. The compute processing power and power consumption of the CT mapper/interpolator 130 depends on the selected interpolation option, which may be controllable using the one or more control parameters. The output image may then be provided to a display buffer for subsequently displaying of the output image.

One drawback is that the size or accuracy (tonal resolution) of the CT LUT is selected to optimize the color transformation of the fovea region of the image, while also considering hardware and power resources to implement the CT LUT. The fovea region of the image is where the user's eyes are directly looking, and not the periphery region of the image. The fovea region of the image provides the user with the most focused and high detail region of the image considering the human vision system. The periphery region of an image is typically out-of-focused and provides less visual acuity for the user than the fovea region. Thus, because the CT LUT is selected to optimize the color transformation of the fovea region of the image (with consideration also to hardware and power resources), the accuracy of the selected CT LUT is significantly more than required for performing the color transformation of the periphery region of the input image. Accordingly, there is a waste of hardware and power resources when it comes to performing color transformation of the periphery region of an input image.

Another drawback is that the apparatus 100 uses a LUT approach to perform color transformation. That is, in an LUT approach, the size or tonal resolution of the LUT is typically fixed based on the product in which it is employed. For example, if it is employed in a smart phone, the LUT may have a relatively small size as high accuracy color transformation may not be needed. On the other hand, if it is employed in an XR viewer, the LUT may have a relatively large size as higher accuracy color transformation may be desired or required. However, such approach is typically not scalable. For example, if a new version of a product is introduced that requires higher color transformation accuracy (e.g., it uses images with a higher tonal resolution or color depth (e.g., 12-bit compared to 8-bit), the LUT used on the previous version of the product may not be capable of performing the desired color transformation. Accordingly, a new LUT hardware design would be needed.

Instead of an LUT approach, which as discussed, may not be readily scalable, a compute-based approach (e.g., performed by a general-purpose processor, central processing unit (CPU), graphics processing unit (GPU), digital signal processor (DSP), data processing unit (DPU), etc.) driven by software may be employed, where merely software updates may be provided to deal with new color transformation requirements; thereby, making the solution more scalable. However, employing a compute-based approach to perform color transformation on an entire image may costs significant compute power, high power consumption, and may not perform the color transformation in a real-time or sufficient-time manner.

FIG. 2 illustrates a block diagram of another example apparatus 200 for performing color transformation in accordance with another aspect of the disclosure. Briefly, the apparatus 200 employs an image separator to separate out a relatively high acuity (HA) area (e.g., fovea region) from a relatively low acuity (LA) area (e.g., periphery region) of a source or input image. Higher tonal resolution color transformation is performed on the HA area of the input image, and lower tonal resolution color transformation is performed on the LA area of the input image. The apparatus 200 further employs an image combiner to combine the color transformed HA sub-image with the color transformed LA sub-image to generate an output image.

In particular, the apparatus 200 includes an HA/LA image separator 210, a higher tonal resolution color transform subsystem 220, a lower resolution color transform subsystem 230, and an image combiner 240. The HA/LA image separator 210 is configured to receive a source or input image, and separate therefrom a HA region (e.g., the fovea region) of the input image and a LA region (e.g., periphery region) of the input image. The higher resolution color transform subsystem 220 is configured to color transform the HA region of the input image to generate a color transformed HA sub-image (CT-HA). The lower resolution color transform subsystem 230 is configured to color transform the LA region of the input image to generate a color transformed LA sub-image (CT-LA). It shall be understood that the HA/LA image separator 210 may be optional as the input image may be internally filtered by the subsystems 220 and 230 to produce the HA and LA regions, respectively.

As some examples, the higher resolution color transform subsystem 220 may use a compute-based color transformer (e.g., CPU, GPU, DSP, DPU, general-purpose processor, etc.), which has the advantage of being updatable through software updates; and thereby, scalable with new product iterations. As the HA region may be a small portion of the input image, performing compute-based color transformation on the HA region may not require that much compute power and power consumption, and may be performed in a real-time or acceptable-time manner. As the higher resolution color transform subsystem 220 may perform the color transformation by computation, higher tonal (color depth) granularity or accuracy color transformation may be achieved compared to the lower resolution color transform subsystem 230.

On the other hand, the lower resolution color transform subsystem 230 may use an LUT to perform the color transformation on the LA region of the input image. As discussed, a high tonal resolution color transformation may not be needed for the LA region as it may pertain to the periphery region of the input image, which the user's vision system perceives it as out-of-focused with lower higher frequency components or image acuity. Thus, newer product iterations with higher color depth may not impact the LA region from a user experience perspective, the LUT-based color transformation approach for the LA region may suffice. It shall be understood that the higher resolution color transform subsystem 220 may also employ an LUT-based color transformation approach, but with a higher sized/accuracy/tonal resolution, and more dimensions color transformation LUT.

The image combiner 240 is configured to receive and combine the color transformed HA sub-image (CT-HA) and the color transformed LA sub-image (CT-LA) to generate an output image. The output image may be provided to a display subsystem for displaying the output image. Thus, the color transformation provided by the apparatus 200 may be scalable with regard to the HA region; may be configured to perform higher tonal resolution and accuracy transformation for improved output images; and may use a lower resolution LUT-based approach more suitable for the LA region from a hardware and power consumption perspective. The following describes various examples of more detailed and/or variations of the apparatus 200.

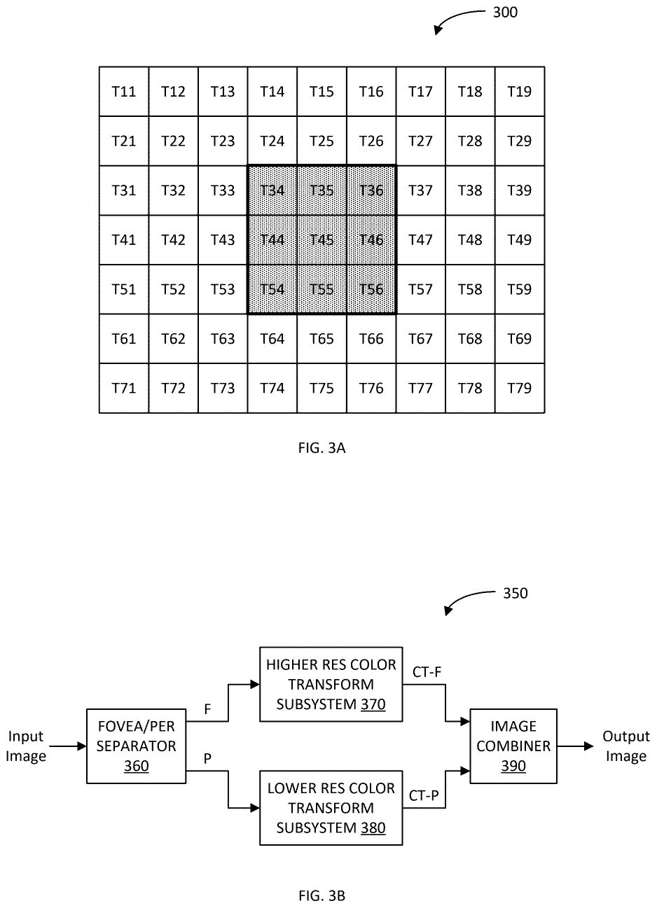

FIG. 3A illustrates a diagram of an example image 300 in accordance with another aspect of the disclosure. The image 300 may be an example source or input image upon which color transformation is to be performed. The image 300 may be subdivided into an array of tiles (e.g., square or rectangular sets of pixels). In this example, the image 300 may be subdivided into seven (7) rows and nine (9) columns of tiles. For examples, tiles T11 to T19 (where the first suffix (e.g., “1”) represents the row, and the second suffix (e.g., 1-9) represents the column) are situated in the first row of tiles; tiles T21 to T29 are situated in the second row of tiles; tiles T31 to T39 are situated in the third row of tiles; and so on, to tiles T71 to T79 situated in the seventh row of tiles.

If the user's eyes are fixated at the center of the image 300, the fovea region of the image 300 may include tiles T34-T36, T44-T46, and T54-T56, as indicated by the dark shaded tiles with a thicker line outlining the fovea region (a convention used herein). The periphery region of the image 300, when the user's eyes are fixated at the center of the image 300, may include those tiles outside of the fovea region. For example, the first two rows T11-T29 and last two rows T61-T79 are in the periphery region of the image 300. The tiles in the left three columns and three middle rows T31-T33, T41-T43, and T51-T53 and right three columns and three middle rows T37-T39, T47-T49, and T57-T59 may also be in the periphery region of the image 300. Thus, with regard to the apparatus 200, the fovea region T34-T36, T44-T46, and T54-T56 may correspond to the HA region of the input image, and the periphery region T11-T29, T31-T33, T41-T43, T51-T53, T37-T39, T47-T49, T57-T59, and T61-T79 may correspond to the LA region of the input image.

FIG. 3B illustrates a block diagram of an example apparatus 350 for performing color transformation on the image 300 in accordance with another aspect of the disclosure. The apparatus 350 may be configured to perform color transformation of a source or input image where the HA or fovea region is at a fixed predefined region of the image. This has the advantage of simplifying the image separator, but may have the drawback of compromising on accuracy of the color transformation as the user may not have his/her eyes fixated at the center of the image.

In particular, the apparatus 350 includes a fovea/periphery image separator 360, a higher tonal resolution color transform subsystem 370, a lower tonal resolution color transform subsystem 380, and an image combiner 390. The fovea/periphery image separator 360 is configured to receive the source or input image 300, and separate therefrom the fovea (F) region (e.g., T34-T36, T44-T46, and T54-T56) of the input image and the periphery (P) region (e.g., T11-T29, T31-T33, T41-T43, T51-T53, T37-T39, T47-T49, T57-T59, and T61-T79) of the input image 300. It shall be understood that the fovea/periphery image separator 360 may be optional as the input image may be internally filtered by the subsystems 370 and 380 to produce the fovea (F) and periphery (P) regions, respectively.

The higher resolution color transform subsystem 370, which may be implemented per higher resolution color transform subsystem 220 previously discussed, is configured to color transform the fovea (F) region of the input image 300 to generate a color transformed fovea (F) sub-image (CT-F). The lower resolution color transform subsystem 380, which may be implemented per higher resolution color transform subsystem 230 previously discussed, is configured to color transform the periphery (P) region of the input image 300 to generate a color transformed periphery (P) sub-image (CT-P). The image combiner 390 is configured to combine the color transformed fovea sub-image (CT-F) with the color transformed periphery sub-image (CT-P) to generate an output image.

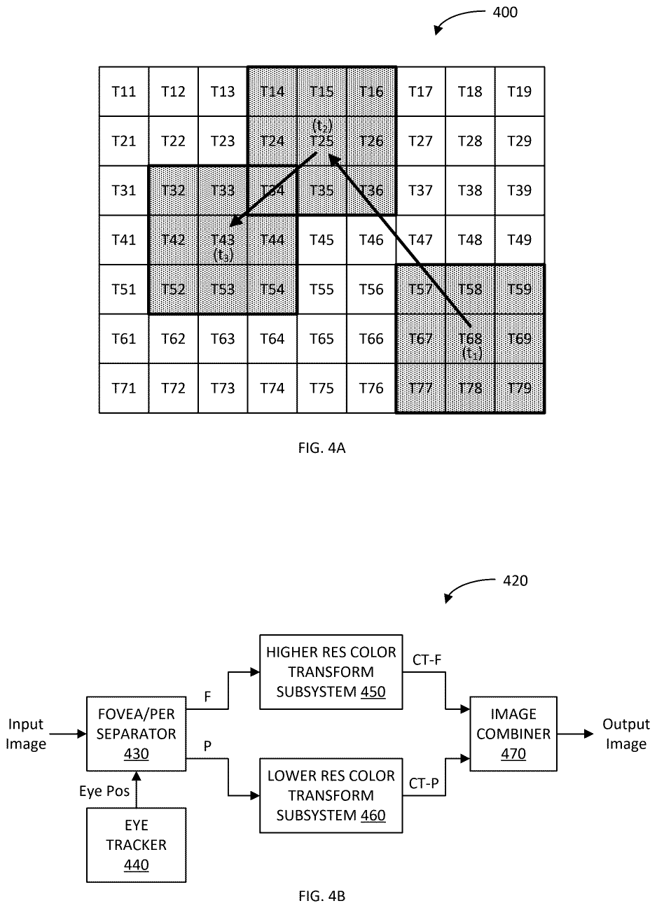

FIG. 4A illustrates a diagram of another example image 400 in accordance with another aspect of the disclosure. In this example, the high acuity (HA) or fovea (F) region may be dynamic as the user's eyes may be fixated on different regions of the image 400 at different times. The image 400 may be subdivided into tiles as per image 300 previously discussed.

In this example, the user, at time t₁, may be looking at the bottom right region of the image 400. At such time, the HA or fovea (F) region may correspond to tiles T57-T59, T67-T69, and T77-T79, and the LA or periphery (P) region may correspond to tiles T11-T49, T51-T56, T61-T66, and T71-T76. At time t₂, the user may be looking at the top middle region of the image 400. At such time, the HA or fovea (F) region may correspond to tiles T14-T16, T24-T26, and T34-T36, and the LA or periphery (P) region may correspond to tiles T11-T13, T17-T19, T21-T23, T27-T29, T31-T33, T37-T39, and T41-T79. Then, at time t₃, the user may be looking at the left middle region of the image 400. At such time, the HA or fovea (F) region may correspond to tiles T32-T34, T42-T44, and T52-T54, and the LA or periphery (P) region may correspond to tiles T11-T29, T31, T35-T39, T41, T45-T49, T51, T55-T59, and T61-T79. With a dynamic HA or fovea (F) region, an image separator of a color transformation apparatus may need to perform image separation based on the position of the user's eyes, as discussed in more detail below.

FIG. 4B illustrates a block diagram of an example apparatus 420 for performing color transformation on the image 400 in accordance with another aspect of the disclosure. The apparatus 420 may be configured to perform color transformation of a source or input image 400 where the HA or fovea region is dynamic. This has the advantage of achieving higher accuracy color transformation as compared to the apparatus 350 that performs color transformation on an image where the HA or fovea region is fixed.

In particular, the apparatus 420 includes a fovea/periphery image separator 430, an eye tracker 440, a higher resolution color transform subsystem 450, a lower resolution color transform subsystem 460, and an image combiner 470. The fovea/periphery image separator 430 is configured to receive the source or input image 400, and separate therefrom the fovea (F) region of the input image 400 and the periphery (P) region of the input image 400 based on the eye position of a user as detected by the eye tracker 440.

Considering the example of input image 400 previous discussed, at time t₁, the eye tracker 440 provides an eye position signal to the fovea/periphery separator 430 indicating that the current HA or fovea (F) region corresponds to tiles T57-T59, T67-T69, and T77-T79, and the LA or periphery (P) region corresponds to tiles T11-T49, T51-T56, T61-T66, and T71-T76. Thus, the fovea/periphery separator 430 separates the HA or fovea (F) region and the LA or periphery (P) region accordingly.

At time t₂, the eye tracker 440 provides an eye position signal to the fovea/periphery separator 430 indicating that the current HA or fovea (F) region corresponds to tiles T14-T16, T24-T26, and T34-T36, and the LA or periphery (P) region corresponds to tiles T11-T13, T17-T19, T21-T23, T27-T29, T31-T33, T37-T39, and T41-T79. Thus, the fovea/periphery separator 430 separates the HA or fovea (F) region and the LA or periphery (P) region accordingly.

At time t₃, the eye tracker 440 provides an eye position signal to the fovea/periphery separator 430 indicating that the current HA or fovea (F) region corresponds to tiles T32-T34, T42-T44, and T52-T54, and the LA or periphery (P) region corresponds to tiles T11-T29, T31, T35-T39, T41, T45-T49, T51, T55-T59, and T61-T79. Thus, the fovea/periphery separator 430 separates the HA or fovea (F) region and the LA or periphery (P) region accordingly.

It shall be understood that the fovea/periphery image separator 430 may be optional as the input image may be internally filtered by the subsystems 450 and 460 to produce the fovea (F) and periphery (P) regions based on the eye position signal generated by the eye tracker 440, respectively. In such case, the eye tracker 440 is coupled to the subsystems 450 and 460.

The higher resolution color transform subsystem 450, which may be implemented per higher resolution color transform subsystem 220 previously discussed, is configured to color transform the fovea (F) regions at times t₁, t₂, and t₃ of input images 400 to generate a color transformed fovea (F) sub-images (CT-F), respectively. The lower resolution color transform subsystem 460, which may be implemented per higher resolution color transform subsystem 230 previously discussed, is configured to color transform the periphery (P) regions at times t₁, t₂, and t₃ of the input images 400 to generate a color transformed periphery (P) sub-images (CT-P), respectively. The image combiner 470 is configured to combine the color transformed fovea sub-images (CT-F) with the color transformed periphery sub-images (CT-P) corresponding to times t₁, t₂, and t₃ to generate output images, respectively.

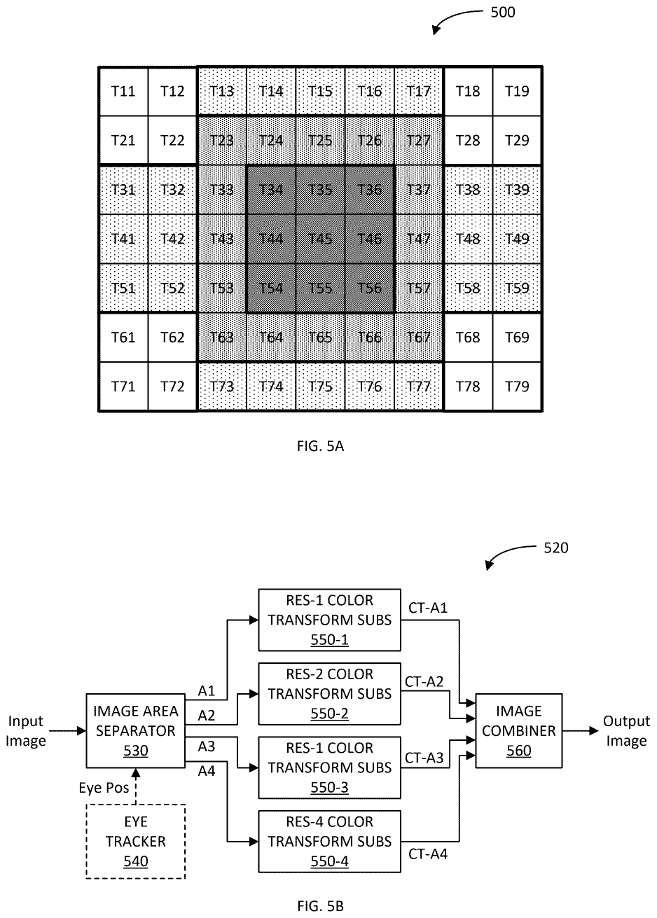

FIG. 5A illustrates a diagram of another example image 500 in accordance with another aspect of the disclosure. In the previous example images 300 and 400, two different regions were identified: the HA or fovea (F) region and the LA or periphery (P) region. However, it shall be understood that separate color transformations with different resolutions/hardware may be performed on a set of regions of a source or input image. The image 500 is an example of such input image with a set of regions that may be processed differently to achieve a color transformation of the input image to generate an output image.

The image 500 may be subdivided into tiles T11-T79 in the same manner as images 300 and 400 previously discussed. In this example, the image 500 includes a first (central) region (darkest shaded region) corresponding to tiles T34-T36, T44-T46, and T54-T56. The image 500 further includes a second (ring) region (medium shaded region) surrounding the first (central) region, corresponding to tiles T23-T27, T33, T37, T43, T47, T53, T57, and T63-T67. The image 500 additionally includes a third region (lightly shaded region) generally surrounding the second region, corresponding to tiles T13-T17, T31-T32, T38-T39, T41-T42, T48-T49, T51-T52, T58-T59, and T73-T77. And, the image 500 includes a fourth region (non-shaded region) at the four (4) corners of the image, corresponding to tiles T11-T12, T21-T22, T18-T19, T28-T29, T61-T62, T71-T72, T68-T69, T78-T79.

The first (central) region may correspond to the fovea region, which may be processed with the highest tonal resolution color transformation process/hardware. The second region, which may be the periphery region closest to the fovea region, may be processed with the second highest tonal resolution color transformation process/hardware. The third region, which may be farther away from the fovea region than the second region, may be processed with the third highest tonal resolution color transformation process/hardware. And, the fourth region, which may be the farthest from the fovea region, may be processed with the fourth highest tonal resolution color transformation process/hardware. It shall be understood that these regions may be fixed or dynamic depending on the position of a user's eyes.

FIG. 5B illustrates a diagram of an example apparatus 520 for performing color transformation on the image 500 in accordance with another aspect of the disclosure. The apparatus 520 includes an image separator 530, an optional eye tracker 540, a first resolution RES-1 (e.g., highest) color transform subsystem 550-1, a second resolution RES-2 (e.g., second highest) color transform subsystem 550-2, a third resolution RES-3 (e.g., third highest) color transform subsystem 550-3, a fourth resolution RES-4 (e.g., fourth highest or lowest) color transform subsystem 550-4, and an image combiner 560.

The image area separator 530 is configured to receive the source or input image 500, and separate the input image 500 into a first region A1 (e.g., tiles T34-T36, T44-T46, and T54-T56), the second region A2 (e.g., tiles T23-T27, T33, T37, T43, T47, T53, T57, and T63-T67), the third region A3 (e.g., tiles T13-T17, T31-T32, T38-T39, T41-T42, T48-T49, T51-T52, T58-T59, and T73-T77), and the fourth region A4 (e.g., tiles T11-T12, T21-T22, T18-T19, T28-T29, T61-T62, T71-T72, T68-T69, and T78-T79). The image are separator 530 may perform the separation based on an eye position signal generated by the optional eye tracker 540; in which case, the tiles corresponding to the regions A1-A4 may vary.

It shall be understood that the fovea/periphery image separator 530 may be optional as the input image may be internally filtered by the subsystems 550-1 to 550-4 to produce the A1 to A4 regions, and optionally, based on the eye position signal generated by the optional eye tracker 540, respectively. In such case, the optional eye tracker 540 is coupled to the subsystems 550-1 to 550-4.

The first resolution RES-1 (e.g., highest) color transform subsystem 550-1 is configured to color transform the first region A1 of the input image 500 to generate a first color transformed sub-image (CT-A1). The second resolution RES-2 (e.g., second highest) color transform subsystem 550-2 is configured to color transform the second region A2 of the input image 500 to generate a second color transformed sub-image (CT-A2). The third resolution RES-3 (e.g., third highest) color transform subsystem 550-3 is configured to color transform the third region A3 of the input image 500 to generate a third color transformed sub-image (CT-A3). And, the fourth resolution RES-4 (e.g., fourth highest or lowest) color transform subsystem 550-4 is configured to color transform the fourth region A4 of the input image 500 to generate a fourth color transformed sub-image (CT-A4). The image combiner 560 is configured to combine the color transformed sub-images CT-A1 to CT-A4 to generate an output image.

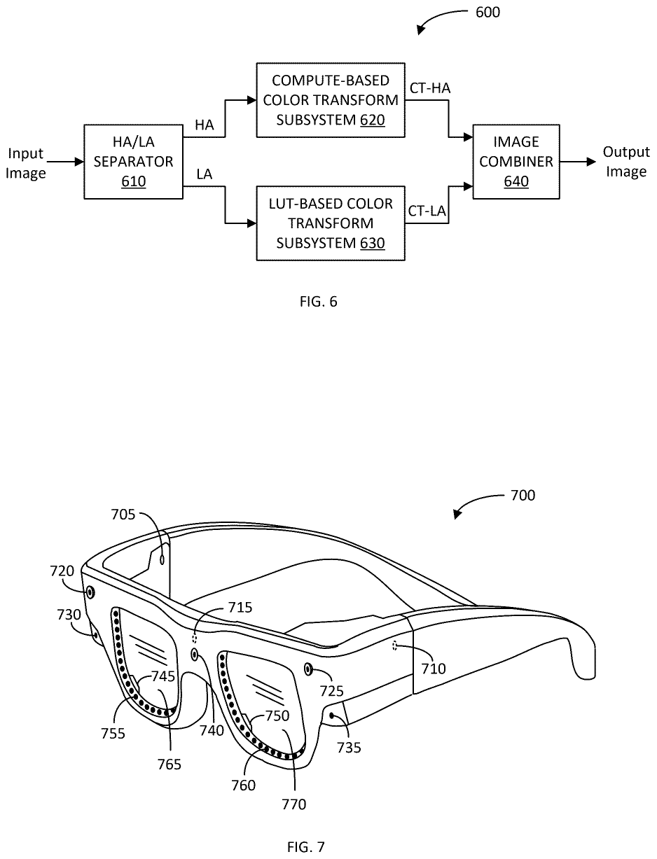

FIG. 6 illustrates a block diagram of another example apparatus 600 for performing color transformation in accordance with an aspect of the disclosure. The apparatus 600 may be configured to perform color transformation of a source or input image, where the HA or fovea region is processed by a compute-based color transform subsystem, and the LA or periphery region is processed by an LUT-based color transform subsystem.

In particular, the apparatus 600 includes a HA/LA image separator 610, a compute-based color transform subsystem 620 (e.g., CPU, GPU, DSP, DPU, etc.), an LUT-based color transform subsystem 630, and an image combiner 640. The HA/LA image separator 610 is configured to receive a source or input image, and separate the input image into an HA region and an LA region. The compute-based color transform subsystem 620 is configured to color transform the HA region of the input image to generate a color transformed HA sub-image (CT-HA). The LUT-based color transform subsystem 630 is configured to color transform the LA region of the input image to generate a color transformed LA sub-image (CT-LA). The image combiner 640 is configured to combine the color transformed HA sub-image (CT-HA) with the color transformed LA sub-image (CT-LA) to generate an output image.

It shall be understood that the HA/LA image separator 610 may be optional as the input image may be internally filtered by the subsystems 620 and 630 to produce the HA and LA regions. Although not shown, the apparatus 600 may also include an eye tracker coupled to the HA/LA separator 610 or the subsystems 620 and 630, as previously discussed in detail.

FIG. 7 illustrates a perspective view of an example wearable device 700 (e.g., an augmented reality (AR) viewer or glasses) in accordance with another aspect of the disclosure. The AR glasses 700 is an example of a wearable device. It shall be understood that a wearable device described herein may take on many different forms, such as other types of viewers or glasses (e.g., virtual reality (VR) viewer or glasses), fitness measurement and tracking devices, health monitoring devices, medical treatment devices, smart watches, earpieces, and others.

The AR glasses 700 may include a set of skin temperature sensors 705, 710, and 715. The skin temperature sensor 705 may be situated on the right temple of the AR glasses 700. The skin temperature sensor 710 may be situated on the left temple of the XR glasses 700. The skin temperature sensor 715 may be positioned on the interior nose bridge of the AR glasses 700. The AR glasses 700 may further includes right and left six-degree of freedom (6DOF) cameras 720 and 725 pointing generally forward, and situated on the exterior right and left rims near the right and left hinges of the AR glasses 700, respectively. The AR glasses 700 may also include right and left infrared (IR) LEDs 730 and 735 also pointing generally forward, and situated near the exterior right and left rims below the right and left 6DOF cameras 720 and 725, respectively. Further, the AR glasses 700 may include a video (e.g., red, green, blue (RGB)) camera 740 pointing generally forward, and situated on the exterior nose bridge of the AR glasses 700.

For eye tracking, the AR glasses 700 may include right and left eye tracking cameras 745 and 750 pointing in the direction of the right and left eyes of a user when the AR glasses are worn, and situated on the interior sides of the right and left rims, respectively. Further, the AR glasses 700 may include right and left infrared (IR) LED rings (e.g., series-connected LEDs) 755 and 760 for illuminating the right and left eye regions of a user when the AR glasses are worn, and situated along the interior surfaces of the right and left rims, respectively. The AR glasses 700 may also include right and left lenses 765 and 770 that also function as right and left displays, respectively. It shall be understood that the aforementioned components, placements, and orientations are merely examples, and such configuration of an AR glasses may take on many different forms.

As discussed below in further detail, the AR glasses 700 may apply color transformation of one or more images captured by any one of the cameras 720, 725, and 740 of the AR glasses. The AR glasses 700 may employ any one of the color transformation apparatuses 200, 350, 420, 520, and 600 described herein. Alternatively, or in addition to, the AR glasses 700 may receive image data from a companion device (e.g., a smart phone), which may be part of a personal area network (PAN) with the AR glasses 700. The companion device may have performed color transformation to generate the image data provided to the AR glasses 700. Accordingly, such companion device may employ any one of the color transformation apparatuses 200, 350, 420, 520, and 600 described herein.

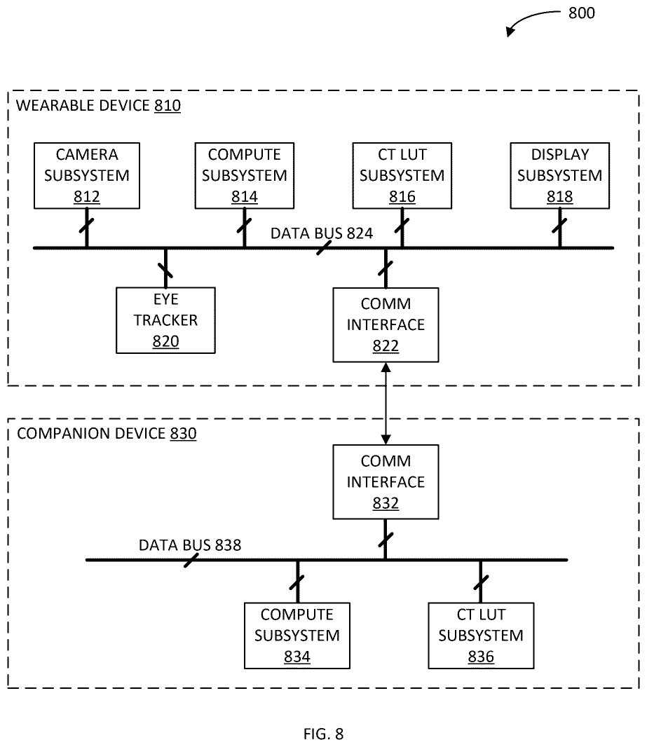

FIG. 8 illustrates a block view of an example personal area network (PAN) 800 in accordance with another aspect of the disclosure. The PAN 800 includes a wearable device 810 (e.g., AR glasses) and a companion device 830 (e.g., a smart phone). The wearable device 810 includes a camera subsystem 812, a compute subsystem 814 (e.g., CPU, GPU, DSP, DPU, general-purpose processor, etc.), a color transformation (CT) lookup table (LUT) subsystem 816, a display subsystem 818, an eye tracker 820, and a communication interface 822, all data coupled together by way of one or more data busses, collectively referred to as data bus 824. The communication interface 822 may be a wired and/or wireless communication interface, such as a wireless local area network (WLAN), WiFi, wireless wide area network (WWAN), cellular, Bluetooth, etc.

As discussed in more detail further herein, the camera subsystem 812 is configured to capture one or more images. The compute subsystem 814 may be configured to perform compute-based color transformation of high acuity (HA) or fovea (F) region of or based on the one or more images received from the camera subsystem 812 via the data bus 824, and optionally, based on user eye position information generated by the eye tracker 820. The CT LUT subsystem 816 may be configured to perform LUT-based color transformation of low acuity (LA) or periphery (P) region of or based on the one or more images received from the camera subsystem 812 via the data bus 824, and optionally based on user eye position information generated by the eye tracker 820.

The compute subsystem 814 may also be configured to combine the one or more color transformed HA or F sub-images of or based on the one or more images with the one or more color transformed LA or P sub-images received from the CT LUT subsystem 816 via the data bus 824 to generate one or more output images, respectively. The display subsystem 818 may receive the one or more output images from the compute subsystem 814 via the data bus 824 for displaying the one or more output images. Alternatively, or in addition to, the wearable device 810 may employ the companion device 830 to perform color transformation on its behalf by sending image information to the companion device 830 via the communication interface 822.

The companion device 830 includes a communication interface 832, a compute subsystem 834 (e.g., CPU, GPU, DSP, DPU, general-purpose processor, etc.), and a color transformation (CT) lookup table (LUT) subsystem 836, all data coupled together by way of a data bus 838. Similarly, the communication interface 832 may also be a wired and/or wireless communication interface, such as wireless local area network (WLAN), WiFi, wireless wide area network (WWAN), cellular, Bluetooth, etc.

The compute subsystem 834 may be configured to perform compute-based color transformation of high acuity (HA) or fovea (F) region of or based on the one or more images received from the wearable device 810 via the communication interface 832 and the data bus 838. Similarly, the CT LUT subsystem 836 may be configured to perform LUT-based color transformation of low acuity (LA) or periphery (P) region of or based on the one or more images received from the wearable device 810 via the communication interface 832 and the data bus 838.

The compute subsystem 834 may also be configured to combine the one or more color transformed HA or F sub-images of or based on the one or more images with the one or more color transformed LA or P sub-images received from the CT LUT subsystem 836 via the data bus 838 to generate one or more output images, respectively. The compute subsystem 834 may send the one or more output images to the wearable device 810 via the communication interface 832 for displaying purposes.

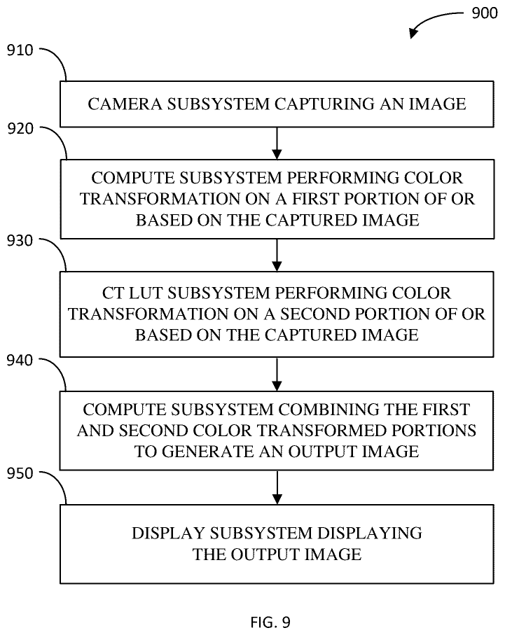

FIG. 9 illustrates a flow diagram of an example method 900 of performing color transformation by the example wearable device 810 in accordance with another aspect of the disclosure. The method 900 is described with respect to a single image for ease of explanation, but it shall be understood that the method 900 may be applicable to a set of images or a time sequence of images as in a video capture.

According to the method 900, the camera subsystem 812 captures an image (block 910). The method 900 further includes the compute subsystem 814 performing color transformation on a first portion of or based on the captured image (block 920). For example, the compute subsystem 814 may process the captured image for purpose other than color transformation, and then the compute subsystem 814 performs color transformation on the first portion of the processed image. Additionally, the method 900 includes the CT LUT subsystem 816 performing color transformation on a second portion of or based on the captured image (block 930). For example, the CT LUT subsystem 816 may receive the processed image from the compute subsystem 814, and may perform color transformation on the second portion of the processed image.

The method 900 further includes the compute subsystem 814 combining the first and second color transformed portions to generate an output image (block 940). For example, the compute subsystem 814 may receive the color transformed second portion from the CT LUT subsystem 816, and then perform the combining of the second portion with the first portion to generate the output image. Then, according to the method 900, the display subsystem 818 displays the output image (block 950).

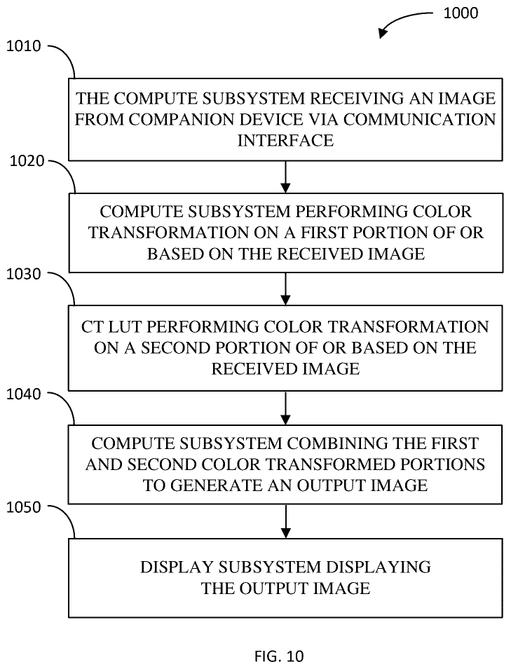

FIG. 10 illustrates a flow diagram of another example method 1000 of performing color transformation by the example wearable device 810 in accordance with another aspect of the disclosure. Similarly, the method 1000 is described with respect to a single image for ease of explanation, but it shall be understood that the method 1000 may be applicable to a set of images or a time sequence of images as in a video capture.

According to the method 1000, the compute subsystem 814 receives an image from the companion device 830 via the communication interface 822 (and the data bus 824) (block 1010). The method 1000 further includes the compute subsystem 814 performing color transformation on a first portion of or based on the received image (block 1020). Additionally, the method 1000 includes the CT LUT subsystem 816 performing color transformation on a second portion of or based on the received image (block 1030). For example, the CT LUT subsystem 816 may receive the image from the compute subsystem 814 via the data bus 824, and may perform color transformation on the second portion of the received image.

The method 1000 further includes the compute subsystem 814 combining the first and second color transformed portions to generate an output image (block 1040). For example, the compute subsystem 814 may receive the color transformed second portion from the CT LUT subsystem 816 via the data bus 824, and then combines the second portion with the first portion to generate the output image. Then, according to the method 1000, the display subsystem 818 displays the output image (block 1050).

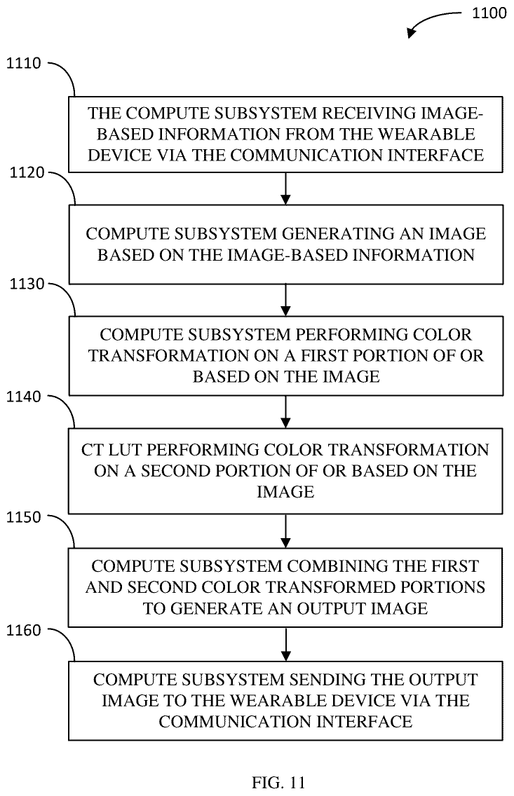

FIG. 11 illustrates a flow diagram of another example method 1100 of performing color transformation by the example companion device 830 on behalf of the example wearable device 810 in accordance with another aspect of the disclosure. As in the previous methods 900 and 1000, the method 1100 is described with respect to a single image for ease of explanation, but it shall be understood that the method 1100 may be applicable to a set of images or a time sequence of images as in a video capture.

According to the method 1100, the compute subsystem 834 receives image-based information from the wearable device 810 via the communication interface 832 (and the data bus 838) (block 1110). For example, the image-based information may pertain to pose information of one or more objects (e.g., a person's face or head) detected in an image captured by the wearable device 810. The method 1100 further includes the compute subsystem 834 generating an image based on the image-based information (block 1120). For example, the image may include graphical content (e.g., graphical eyeglasses or a hat) to be added to the image captured by the wearable device 810 (e.g., superimpose the eyeglasses or hat on the person's face or head).

The method 1100 further includes the compute subsystem 834 performing color transformation on a first portion of or based on the image (block 1130). Additionally, the method 1100 includes the CT LUT subsystem 836 performing color transformation on a second portion of or based on the image (block 1140). For example, the CT LUT subsystem 836 may receive the image from the compute subsystem 834 via the data bus 838, and may perform color transformation on the second portion of the image.

The method 1100 further includes the compute subsystem 834 combining the first and second color transformed portions to generate an output image (block 1150). For example, the compute subsystem 834 may receive the color transformed second portion from the CT LUT subsystem 836 via the data bus 838, and then combines the second portion with the first portion to generate the output image. Then, according to the method 1100, the compute subsystem 834 sends the output image to the wearable device via the communication interface 832 (and the data bus 838) (block 1160).

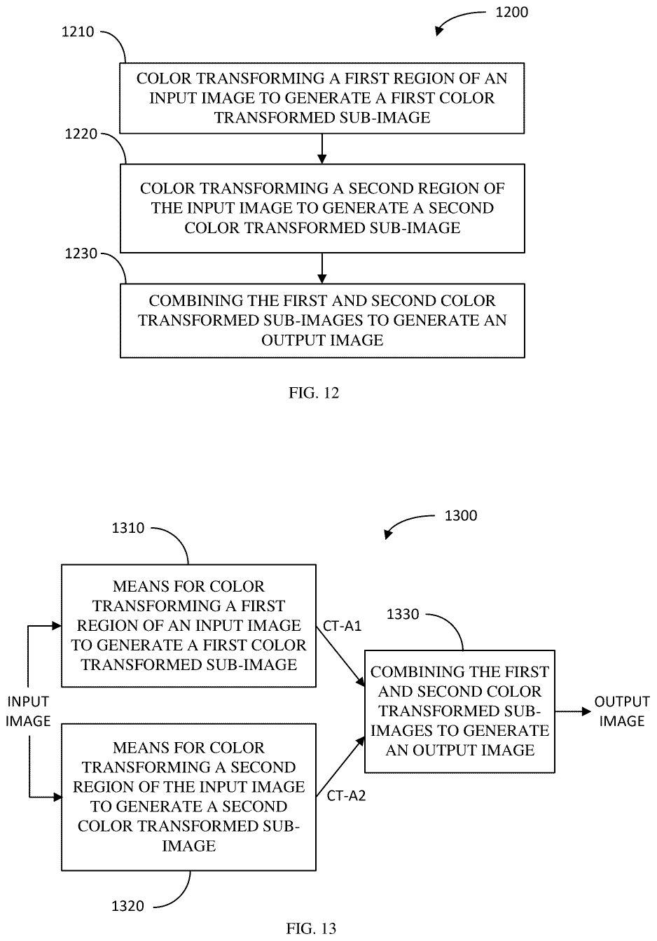

FIG. 12 illustrates a flow diagram of another example method 1200 of performing color transformation of an input image in accordance with another aspect of the disclosure. The method 1200 includes color transforming a first region of an input image to generate a first color transformed sub-image (block 1210). The method 1200 further includes color transforming a second region of the input image to generate a second color transformed sub-image (block 1220). Additionally, the method 1200 includes combining the first and second color transformed sub-images to generate an output image (block 1230).

FIG. 13 illustrates a flow diagram of another example apparatus 1300 for performing color transformation of an input image in accordance with another aspect of the disclosure. The apparatus 1300 includes means 1310 for color transforming a first region of an input image to generate a first color transformed sub-image. The apparatus 1300 further includes means 1320 for color transforming a second region of the input image to generate a second color transformed sub-image. Additionally, the apparatus 1300 includes means 1330 for combining the first and second color transformed sub-images to generate an output image.

Some of the components described herein, such as one or more of the subsystems, thermal controllers, and communication interfaces, may be implemented using a processor. A processor, as used herein, may be any dedicated circuit, processor-based hardware, a processing core of a system on chip (SOC), etc. Hardware examples of a processor may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor may be coupled to memory (e.g., generally a computer-readable media or medium), such as a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

The following provides an overview of aspects of the present disclosure:
Aspect 1: An apparatus, comprising: a first color transform subsystem configured to color transform a first region of an input image to generate a first color transformed sub-image; a second color transform subsystem configured to color transform a second region of the input image to generate a second color transformed sub-image; and an image combiner configured to combine the first and second color transformed sub-images to generate an output image.
Aspect 2: The apparatus of aspect 1, wherein: the first color transform subsystem is configured to color transform the first region of the input image in accordance with a first tonal resolution; and the second color transform subsystem is configured to color transform the second region of the input image in accordance with a second tonal resolution, wherein the first tonal resolution is higher than the second tonal resolution.
Aspect 3: The apparatus of aspect 1 or 2, wherein: the first color transform subsystem comprises a compute-based color transform subsystem; and the second color transform subsystem comprises a lookup table (LUT)-based color transform subsystem.
Aspect 4: The apparatus of aspect 1 or 2, wherein: the first color transform subsystem comprises a first lookup table (LUT)-based color transform subsystem; and the second color transform subsystem comprises a second LUT-based color transform subsystem.
Aspect 5: The apparatus of claim 4, wherein: the first LUT-based color transform subsystem includes a first LUT size; and the second LUT-based color transform subsystem includes a second LUT size, wherein the first LUT size is larger than the second LUT size.
Aspect 6: The apparatus of aspect 4 or 5, wherein: the first LUT-based color transform subsystem includes a first LUT; and the second LUT-based color transform subsystem includes a second LUT, wherein a number of dimensions of the first LUT is greater than a number of dimensions of the second LUT.
Aspect 7: The apparatus of any one of aspects 4-6, wherein: the first LUT-based color transform subsystem is configured to apply an interpolation of the first region of the input image with respect to indices of a first LUT to generate the first color transformed sub-image; and the second LUT-based color transform subsystem is configured to map the second region of the input image to indices of a second LUT to generate the second color transformed sub-image.
Aspect 8: The apparatus of any one of aspects 1-7, wherein: the first region comprises a fovea region of the input image; and the second region comprises a periphery region of the input image.
Aspect 9: The apparatus of aspect 8, wherein the fovea and periphery regions of the input image are predefined fixed regions of the input image.
Aspect 10: The apparatus of aspect 8, further comprising an eye tracker configured to generate an eye position signal indicative of a position of a user's eyes, wherein the fovea and periphery regions of the input image are based on the eye position signal.
Aspect 11: The apparatus of any one of aspects 1-10, further comprising an image separator configured to separate the first and second regions of the input image.
Aspect 12: The apparatus of aspect 11, further comprising an eye tracker configured to generate an eye position signal indicative of a position of a user's eyes, wherein the image separator is configured to separate the first and second regions of the input image based on the eye position signal.
Aspect 13: The apparatus of any one of aspects 1-12, further comprising at least one other color transform subsystem configured to color transform at least one other region of the input image to generate at least one other color transformed sub-image, respectively, wherein the image combiner is configured to combine the at least one other color transformed sub-image with the first and second color transformed sub-images to generate the output image.
Aspect 14: The apparatus of any one of aspects 1-13, further comprising a camera subsystem configured to generate the input image or an image upon which the input image is based.
Aspect 15: The apparatus of any one of aspects 1-14, further comprising a communication interface, wherein the input image or an image upon which the input image is based is received from another apparatus via the communication interface.
Aspect 16: The apparatus of any one of aspects 1-15, further comprising a display subsystem configured to display the output image.
Aspect 17: The apparatus of any one of aspects 1-16, further comprising a communication interface, wherein the output image is sent to another apparatus via the communication interface.
Aspect 18: A method, comprising: color transforming a first region of an input image to generate a first color transformed region of an output image; color transforming a second region of the input image to generate a second color transformed region of the output image; and combining the first and second color transformed regions to generate the output image.
Aspect 19: The method of aspect 18, wherein: color transforming the first region of the input image is in accordance with a first tonal resolution; and color transforming the second region of the input image is in accordance with a second tonal resolution, wherein the first tonal resolution is higher than the second tonal resolution.
Aspect 20: The method of aspect 18 or 19, wherein: color transforming the first region comprises performing a computation of color information associated with the first region to generate color information associated with the first color transformed sub-image; and color transforming the second region comprises using color information associated with the second region to index a lookup table (LUT) to access color information associated with the second color transformed sub-image.
Aspect 21: The method of any one of aspects 18-20, wherein: the first region comprises a fovea region of the input image; and the second region comprises a periphery region of the input image.
Aspect 22: The method of aspect 21, further comprising tracking a position of a user's eyes to identify the fovea and periphery regions of the input image.
Aspect 23: An apparatus, comprising: means for color transforming a first region of an input image to generate a first color transformed sub-image; means for color transforming a second region of the input image to generate a second color transformed sub-image; and means for combining the first and second color transformed sub-images to generate an output image.
Aspect 24: The apparatus of aspect 23, wherein: the means for color transforming the first region of the input image performs color transformation in accordance with a first tonal resolution; and the means for color transforming the second region of the input image performs color transformation in accordance with a second tonal resolution, wherein the first tonal resolution is higher than the second tonal resolution.
Aspect 25: The apparatus of aspect 23 or 24, wherein: the means for color transforming the first region comprises means for performing a computation of color information associated with the first region to generate color information associated with the first color transformed sub-image; and the means for color transforming the second region comprises means for indexing a lookup table (LUT) with color information of the second region to access color information associated with the second color transformed sub-image.
Aspect 26: The apparatus of any one of aspects 23-25, wherein: the first region comprises a fovea region of the input image; and the second region comprises a periphery region of the input image.
Aspect 27: The apparatus of aspect 26, further comprising means for tracking a position of a user's eyes to identify the fovea and periphery regions of the input image.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

1. An apparatus, comprising:
a first color transform subsystem configured to color transform a first region of an input image to generate a first color transformed sub-image;
a second color transform subsystem configured to color transform a second region of the input image to generate a second color transformed sub-image; and
an image combiner configured to combine the first and second color transformed sub-images to generate an output image.

2. The apparatus of claim 1, wherein:
the first color transform subsystem is configured to color transform the first region of the input image in accordance with a first tonal resolution; and
the second color transform subsystem is configured to color transform the second region of the input image in accordance with a second tonal resolution, wherein the first tonal resolution is higher than the second tonal resolution.

3. The apparatus of claim 1, wherein:
the first color transform subsystem comprises a compute-based color transform subsystem; and
the second color transform subsystem comprises a lookup table (LUT)-based color transform subsystem.

4. The apparatus of claim 1, wherein:
the first color transform subsystem comprises a first lookup table (LUT)-based color transform subsystem; and
the second color transform subsystem comprises a second LUT-based color transform subsystem.

5. The apparatus of claim 4, wherein:
the first LUT-based color transform subsystem includes a first LUT size; and
the second LUT-based color transform subsystem includes a second LUT size, wherein the first LUT size is larger than the second LUT size.

6. The apparatus of claim 4, wherein:
the first LUT-based color transform subsystem includes a first LUT; and
the second LUT-based color transform subsystem includes a second LUT, wherein a number of dimensions of the first LUT is greater than a number of dimensions of the second LUT.

7. The apparatus of claim 4, wherein:
the first LUT-based color transform subsystem is configured to apply an interpolation of the first region of the input image with respect to indices of a first LUT to generate the first color transformed sub-image; and
the second LUT-based color transform subsystem is configured to map the second region of the input image to indices of a second LUT to generate the second color transformed sub-image.

8. The apparatus of claim 1, wherein:
the first region comprises a fovea region of the input image; and
the second region comprises a periphery region of the input image.

9. The apparatus of claim 8, wherein the fovea and periphery regions of the input image are predefined fixed regions of the input image.

10. The apparatus of claim 8, further comprising an eye tracker configured to generate an eye position signal indicative of a position of a user's eyes, wherein the fovea and periphery regions of the input image are based on the eye position signal.

11. The apparatus of claim 1, further comprising an image separator configured to separate the first and second regions of the input image.

12. The apparatus of claim 11, further comprising an eye tracker configured to generate an eye position signal indicative of a position of a user's eyes, wherein the image separator is configured to separate the first and second regions of the input image based on the eye position signal.

13. The apparatus of claim 1, further comprising at least one other color transform subsystem configured to color transform at least one other region of the input image to generate at least one other color transformed sub-image, respectively, wherein the image combiner is configured to combine the at least one other color transformed sub-image with the first and second color transformed sub-images to generate the output image.

14. The apparatus of claim 1, further comprising a camera subsystem configured to generate the input image or an image upon which the input image is based.

15. The apparatus of claim 1, further comprising a communication interface, wherein the input image or an image upon which the input image is based is received from another apparatus via the communication interface.

16. The apparatus of claim 1, further comprising a display subsystem configured to display the output image.

17. The apparatus of claim 1, further comprising a communication interface, wherein the output image is sent to another apparatus via the communication interface.

18. A method, comprising:
color transforming a first region of an input image to generate a first color transformed sub-image;
color transforming a second region of the input image to generate a second color transformed sub-image; and
combining the first and second color transformed sub-images to generate an output image.

19. The method of claim 18, wherein:
color transforming the first region of the input image is in accordance with a first tonal resolution; and
color transforming the second region of the input image is in accordance with a second tonal resolution, wherein the first tonal resolution is higher than the second tonal resolution.

20. The method of claim 18, wherein:
color transforming the first region comprises performing a computation of color information associated with the first region to generate color information associated with the first color transformed sub-image; and
color transforming the second region comprises using color information associated with the second region to index a lookup table (LUT) to access color information associated with the second color transformed sub-image.

21-27. (canceled)
